(19) United States
(12) Patent Application Publication
(10) Pub. No.: US 2022/0018033 A1
(43) Pub. Date: Jan. 20, 2022

(54) METHOD FOR PREPARING A CATALYTIC MATERIAL OF AN ELECTRODE FOR ELECTROCHEMICAL REDUCTION REACTIONS PREPARED BY ELECTROREDUCTION

(71) Applicant: IFP Energies nouvelles, Rueil-Malmaison Cedex (FR)

(72) Inventors: Audrey BONDUELLE-SKRZYPCZAK, Rueil-Malmaison Cedex (FR); Sofiane BELAID, Rueil-Malmaison Cedex (FR); David PASQUIER, Rueil-Malmaison Cedex (FR); Emmanuelle TRELA-BAUDOT, Rueil-Malmaison Cedex (FR)

(73) Assignee: IFP Energies nouvelles, Rueil-Malmaison Cedex (FR)

(21) Appl. No.: 17/295,775

(22) PCT Filed: Nov. 19, 2019
(86) PCT No.: PCT/EP2019/081705

§ 371 Date: May 20, 2021

(30) Foreign Application Priority Data
Nov. 30, 2018 (FR) 1872181

(51) Int. Cl. C25B 11/091; C25B 3/07; C25B 11/065; H01M 8/0656; C25B 1/27; C25B 1/04; C25B 13/00; C25B 9/19

(52) U.S. Cl. CPC C25B 11/091; C25B 3/07; C25B 11/065; C25B 9/19; C25B 1/27; C25B 1/04; C25B 13/00; H01M 8/0656

(57) ABSTRACT

A method for preparing a catalytic material of an electrode for electrochemical reduction reactions, which comprises: a) a step of electrolysis of at least one aqueous and/or organic solution comprising at least one precursor of the active phase comprising at least one group VIB metal in order to obtain a solution comprising at least one precursor comprising at least one group VIB metal which has been partially reduced; b) a step of impregnation of said support with said solution obtained in step a) in order to obtain a catalytic material precursor; c) a step of drying said precursor obtained in step b) at a temperature below 250° C., without subsequent calcination; d) a step of sulfurization of the catalytic material precursor obtained in step c) at a temperature of between 100° C. and 600° C.

### FIELD OF THE INVENTION

The present invention relates to the field of electrochemistry, and more particularly to electrodes capable of being used for electrochemical reduction reactions, in particular for the electrolysis of water in a liquid electrolytic medium in order to produce hydrogen.

The present invention relates to a process for the preparation of a catalytic material of an electrode comprising an active phase comprising at least one metal from group VI obtained from a solution comprising at least one element from group VI existing in electroreduced form.

### STATE OF THE ART

During recent decades, significant efforts in research and development have been carried out to improve the technologies making possible the direct conversion of incident solar radiation into electricity by the photovoltaic effect, the conversion into electricity of the energy of moving air masses by virtue of wind turbines or the conversion into electricity, by virtue of hydroelectric processes, of the potential energy of the water of the oceans evaporated and condensed at altitude. Due to their intermittent nature, these renewable energies benefit from being upgraded by combining them with an energy storage system to compensate for their lack of continuity. The possibilities considered are batteries, compressed air, reversible dams or energy carriers, such as hydrogen. For the latter, the electrolysis of water is the most advantageous route because it is a clean production method (no carbon emission when it is coupled with a renewable energy source) and provides hydrogen of high purity.

In a water electrolysis cell, the hydrogen evolution reaction (HER) occurs at the cathode and the oxygen evolution reaction (OER) occurs at the anode. The overall reaction is:

H₂O→H₂+½O₂

Catalysts are necessary for both reactions. Different metals have been studied as catalysts for the reaction for the production of molecular hydrogen at the cathode. Today, platinum is the most widely used metal because it exhibits a negligible overvoltage (voltage necessary to dissociate the water molecule) compared to other metals. However, the scarcity and cost (>25 k€/kg) of this noble metal are brakes on the economic development of the hydrogen sector in the long term. This is the reason why, for a number of years now, researchers have been moving toward new catalysts without platinum but based on inexpensive metals which are abundant in nature.

The production of hydrogen by electrolysis of water is fully described in the work: “Hydrogen Production: Electrolysis”, 2015, edited by Agata Godula-Jopek. The electrolysis of water is an electrolytic process which breaks down water into gaseous O₂ and H₂ with the help of an electric current. The electrolytic cell is constituted by two electrodes—usually made of inert metal (inert in the potential and pH zone considered), such as platinum—immersed in an electrolyte (in this instance water itself) and connected to the opposite poles of the direct current source.

The electric current dissociates the water (H₂O) molecule into hydroxide (HO⁻) and hydrogen (H⁺) ions: in the electrolytic cell, the hydrogen ions accept electrons at the cathode in an oxidation/reduction reaction with the formation of gaseous molecular hydrogen (H₂), according to the reduction reaction:

2H⁻++2e⁻→H₂.

A detailed account of the composition and of the use of the catalysts for the production of hydrogen by electrolysis of water is widely covered in the literature and mention may be made of a review paper bringing together the families of advantageous materials under development in the last ten years: “Recent Development in Hydrogen Evolution Reaction Catalysts and Their Practical Implementation”, 2015, P. C. K. Vesborg et al., where the authors describe sulfides, carbides and phosphides as potential new electrocatalysts. Among the sulfide phases, dichalcogenides, such as molybdenum sulfide MoS₂, are very promising materials for the hydrogen evolution reaction (HER) due to their high activity, excellent stability and availability, molybdenum and sulfur being abundant elements on earth and of low cost.

Materials based on MoS₂ have a lamellar structure and can be promoted by Ni or Co for the purpose of increasing their electrocatalytic activity. The active phases can be used in bulk form when the conduction of the electrons from the cathode is sufficient or else in the supported state, then bringing into play a support of a different nature.

In the latter case, the support must have specific properties:
high specific surface in order to promote the dispersion of the active phase;
very good electron conductivity;
chemical and electrochemical stability under water electrolysis conditions (acidic medium and high potential).

Carbon is the commonest support used in this application. The whole challenge lies in the preparation of this sulfide-based phase on the conductive material.

It is accepted that a catalyst exhibiting a high catalytic potential is characterized by an associated active phase perfectly dispersed at the surface of the support and exhibiting a high active phase content. It should also be noted that, ideally, the catalyst should exhibit accessibility of the active sites with respect to the reactants, in this instance water, while developing a high active surface area, which can result in specific constraints in terms of structure and texture which are suitable for the constituent support of said catalysts.

The usual methods resulting in the formation of the active phase of the catalytic materials for the electrolysis of water consist of a deposit of precursor(s) comprising at least one metal from group VIb, and optionally at least one metal from group VIII, on a support by the “dry impregnation” technique or by the “excess impregnation” technique, followed by at least one optional heat treatment to remove the water and by a final stage of sulfurization which generates the active phase, as mentioned above.

It appears advantageous to find means for the preparation of catalysts for the production of hydrogen by electrolysis of water, making it possible to obtain new catalysts having improved performance qualities. The prior art shows that researchers have turned toward several methods, including the deposition of Mo precursors in the form of ammonium salts or oxides or heptamolybdate, followed by a stage of sulfurization in the gas phase or in the presence of a chemical reducing agent.

By way of example, Chen et al., “Recent Development in Hydrogen Evolution Reaction Catalysts and Their Practical Implementation”, 2011, provide for the synthesis of a MoS₂ catalyst by sulfurization of MoO₃ at different temperatures under a H₂S/H₂ gas mixture with a 10/90 ratio. Kibsgaard et al., “Engineering the surface structure of MoS₂ to preferentially expose active edge sites for electrocatalysis”, 2012, provide for the electrodeposition of Mo on a Si support from a peroxopolymolybdate solution and then for the implementation of a stage of sulfurization at 200° C. under a H₂S/H₂ gas mixture with a 10/90 ratio. Bonde et al., “Hydrogen evolution on nano-particulate transition metal sulfides”, 2009, provide for the impregnation of a carbon support with an aqueous ammonium heptamolybdate solution, for drying it in air at 140° C. and then for carrying out a sulfurization at 450° C. under a H₂S/H₂ gas mixture with a 10/90 ratio for 4 hours. Benck et al., “Amorphous Molybdenum Sulfide Catalysts for Electrochemical Hydrogen Production: Insights into the Origin of their Catalytic Activity”, 2012, synthesized a MoS₂ catalyst by mixing an aqueous ammonium heptamolybdate solution with a sulfuric acid solution and then, in a second stage, a sodium sulfide solution in order to form MoS₂ nanoparticles.

A method of preparation consisting of the decomposition of a thiomolybdic salt by virtue of a reducing agent should also be pointed out. Li et al., “MoS₂ Nanoparticles Grown on Graphene: An Advanced Catalyst for Hydrogen Evolution Reaction”, 2011, thus synthesized a MoS₂ catalyst on a graphene support starting from (NH₄)₂MoS₄, a DMF solution and a N₂H₄.H₂O solution.

The applicant company has discovered, surprisingly, that a process for the preparation of a catalytic electrode material capable of being used for electrochemical reduction reactions, in which a solution comprising at least one precursor of said catalytic material comprising at least one metal from group VIb is reduced electrochemically beforehand, makes it possible to obtain catalytic performance qualities, in particular in terms of activity, which are at least as good as, indeed even better than, the catalytic electrode materials prepared according to the prior art, while dispensing with the introduction of any additional chemical reducing agent potentially deleterious to the catalytic activity.

### Subject Matters of the Invention

A first subject matter according to the invention relates to a process for the preparation of a catalytic material of an electrode for electrochemical reduction reactions, said material comprising at least one active phase based on a metal from group VIb and an electroconductive support, which process comprises at least the following stages:
a) a stage of electrolysis of at least one aqueous and/or organic solution comprising at least one precursor of the active phase comprising at least one metal from group VIb, in order to obtain a solution comprising at least one precursor comprising at least one partially reduced metal from group VIb;
b) a stage of impregnation of said support with said solution obtained in stage a), in order to obtain a catalytic material precursor;
c) a stage of drying said precursor obtained in stage b) at a temperature of less than 250° C., without subsequent calcination;
d) a stage of sulfurization of the catalytic material precursor obtained in stage c) at a temperature of between 100° C. and 600° C.

Preferably, stage a) is carried out in an electrolyzer comprising at least two electrochemical compartments separated by a membrane or a porous separator and respectively including one the anode and the other the cathode.

Preferably, the current density applied in stage a) is between 5 and 500 mA/cm².

Preferably, said precursor comprising at least one metal from group VI is chosen from polyoxometallates corresponding to the formula (HₕXₓMₘO_{y})^{q-} in which X is an element chosen from phosphorus (P), silicon (Si), boron (B), nickel (Ni) and cobalt (Co), M is one or more metal(s) chosen from molybdenum (Mo), tungsten (W), nickel (Ni), cobalt (Co) and iron (Fe), O being oxygen, h being an integer between 0 and 12, x being an integer between 0 and 4, m being an integer equal to 5, 6, 7, 8, 9, 10, 11, 12 and 18, y being an integer between 17 and 72 and q being an integer between 1 and 20, it being understood that M is not a nickel atom or a cobalt atom alone.

In one embodiment according to the invention, the m atoms M are either only molybdenum (Mo) atoms, or only tungsten (W) atoms, or a mixture of molybdenum (Mo) and tungsten (W) atoms, or a mixture of molybdenum (Mo) and cobalt (Co) atoms, or a mixture of molybdenum (Mo) and nickel (Ni) atoms, or a mixture of tungsten (W) and nickel (Ni) atoms.

In one embodiment according to the invention, the m atoms M are either a mixture of nickel (Ni), molybdenum (Mo) and tungsten (W) atoms, or a mixture of cobalt (Co), molybdenum (Mo) and tungsten (W) atoms.

In one embodiment according to the invention, at least one precursor of the active phase comprising at least one metal from group VIII is introduced, said precursor being brought into contact with the electroconductive support by impregnation, either:
i) before stage b) of impregnation of said support with the solution obtained in stage a), in a “preimpregnation” stage b1) using a solution comprising at least one precursor of the active phase comprising at least one metal from group VIII;
ii) during the impregnation stage b), in coimpregnation with said solution comprising at least one precursor of the active phase comprising at least one partially reduced metal from group VIb obtained in stage a);
iii) after the drying stage c), in a “postimpregnation” stage b2), using a solution containing at least one precursor of the active phase comprising at least one metal from group VIII;
iv) after the sulfurization stage c), in a “postimpregnation” stage b3) using a solution comprising at least one precursor of the active phase comprising at least one metal from group VIII.

Preferably, said metal from group VIII is chosen from nickel, cobalt and iron.

In one embodiment according to the invention, when said precursor of the catalytic material comprises at least one metal from group VIb and at least one metal from group VIII, the sulfurization temperature is between 350° C. and 550° C.

In one embodiment according to the invention, when said precursor of the catalytic material comprises only that at least one metal from group VIb, the sulfurization temperature is between 100° C. and 250° C. or between 400° C. and 600° C.

In one embodiment according to the invention, said electroconductive support comprises at least one material chosen from carbon structures of carbon black, graphite, carbon nanotubes or graphene type.

In one embodiment according to the invention, said electroconductive support comprises at least one material chosen from gold, copper, silver, titanium or silicon.

Another subject matter according to the invention relates to an electrode, characterized in that it is formulated by a preparation process comprising the following stages:
1) at least one ionic conductive polymer binder is dissolved in a solvent or a solvent mixture;
2) at least one catalytic material prepared according to the invention, in powder form, is added to the solution obtained in stage 1) in order to obtain a mixture; stages 1) and 2) being carried out in any order or simultaneously;
3) the mixture obtained in stage 2) is deposited on a metallic or metallic-type conductive support or collector.

Another subject matter according to the invention relates to an electrolysis device comprising an anode, a cathode and an electrolyte, said device being characterized in that one at least of the anode or of the cathode is an electrode according to the invention.

Another subject-matter according to the invention relates to the use of the electrolysis device according to the invention in electrochemical reactions as:
water electrolysis device for the production of a gaseous mixture of hydrogen and oxygen and/or the production of hydrogen alone;
carbon dioxide electrolysis device for the production of formic acid,
nitrogen electrolysis device for the production of ammonia;
fuel cell device for the production of electricity from hydrogen and oxygen.

### DESCRIPTION OF THE INVENTION

### Definitions

Subsequently, the groups of chemical elements are given according to the CAS classification (CRC Handbook of Chemistry and Physics, published by CRC Press, editor D. R. Lide, 81^{st} edition, 2000-2001). For example, group VIII according to the CAS classification corresponds to the metals from columns 8, 9 and 10 according to the new IUPAC classification.

BET specific surface is understood to mean the specific surface determined by nitrogen adsorption in accordance with the standard ASTM D 3663-78 drawn up from the Brunauer-Emmett-Teller method described in the periodical The Journal of the American Chemical Society, 60, 309 (1938).

Catalytic precursor comprising at least one metal from group VIb in partially reduced form is understood to mean a precursor, at least one atom of metal from group VIb of which exhibits a valency of less than 6.

### DETAILED DESCRIPTION

The preparation process according to the invention makes it possible to carry out the prior reduction of a solution containing at least one precursor of the active phase of the catalytic material comprising at least one metal from group VIb by an electrochemical route, making it possible to obtain performance qualities at least as good in terms of activity, indeed even improved, as the materials prepared according to the prior art, while dispensing with the introduction of any additional chemical reducing agent (which is potentially toxic, such as hydrazine) and/or potentially deleterious to the catalytic activity.

The present invention relates to a process for the preparation of catalytic electrode material for carrying out an electrochemical reduction reaction, and in particular for the production of hydrogen by electrolysis of water, said catalytic material comprising at least one metal from group VIb, and optionally from group VIII, starting from a solution comprising at least one precursor of the active phase comprising at least one electroreduced metal from group VIb, which has undergone an electrolysis via an electrochemical assembly, making it possible to generate a portion of the atoms of the metal from group VIb at a lower valency than that of their normal VIb valency, such as it is in molybdates, tungstates, polymolybdates and polytungstates.

More particularly, the process for the preparation of a catalytic material of an electrode for electrochemical reduction reactions, said material comprising at least one active phase based on a metal from group VIb and an electroconductive support, comprises at least the following stages:
a) a stage of electrolysis of at least one aqueous and/or organic solution comprising at least one precursor of the active phase comprising at least one metal from group VIb, in order to obtain a solution comprising at least one precursor comprising at least one partially reduced metal from group VIb;
b) a stage of impregnation of said support with said solution obtained in stage a), in order to obtain a catalytic material precursor;
c) a stage of drying said precursor obtained in stage b) at a temperature of less than 250° C., without subsequent calcination;
d) a stage of sulfurization of the catalytic material precursor obtained in stage c) at a temperature of between 100° C. and 600° C.

According to the invention, calcination is understood to mean any heat treatment carried out at a temperature of greater than or equal to 250° C., in an atmosphere comprising O₂.

Stage a) of the preparation process according to the invention makes it possible to reduce at least a portion of the metals from group VIb to a valency of less than +6.

Precursors Comprising at Least One Metal from Group VIb

The precursors of the active phase comprising at least one metal from group VIb can be chosen from all the precursors of elements from group VIb known to a person skilled in the art.

They can be chosen from the polyoxometallates (POMs) or the salts of precursors of elements from group VIb, such as molybdates, thiomolybdates, tungstates or also thiotungstates. They can be chosen from organic or inorganic precursors, such as MoCl₅ or WCl₄ or WCl₆ or Mo or W alkoxides, for example Mo(OEt)₅ or W(OEt)₅.

In the context of the present invention, polyoxometallates (POMs) is understood as being the compounds corresponding to the formula (HₕXₓMₘO_{y})^{q-} in which H is hydrogen, X is an element chosen from phosphorus (P), silicon (Si), boron (B), nickel (Ni) and cobalt (Co), said element being taken alone, M is one or more element(s) chosen from molybdenum (Mo), tungsten (W), nickel (Ni), cobalt (Co) and iron (Fe), O being oxygen, h being an integer between 0 and 12, x being an integer between 0 and 4, m being an integer equal to 5, 6, 7, 8, 9, 10, 11, 12 and 18, y being an integer between 17 and 72 and q being an integer between 1 and 20.

Preferably, the element M cannot be a nickel atom or a cobalt atom alone.

The polyoxometallates defined according to the invention encompass two families of compounds: isopolyanions and heteropolyanions. These two families of compounds are defined in the paper Heteropoly and Isopoly Oxometallates, Pope, published by Springer-Verlag, 1983.

The isopolyanions which can be used in the present invention are polyoxometallates of general formula (HₕXₓMₘO_{y})^{q-} in which x=0, the other elements having the abovementioned meanings.

Preferably, the m atoms M of said isopolyanions are either solely molybdenum atoms, or solely tungsten atoms, or a mixture of molybdenum and tungsten atoms, or a mixture of molybdenum and cobalt atoms, or a mixture of molybdenum and nickel atoms, or a mixture of tungsten and cobalt atoms, or a mixture of tungsten and nickel atoms.

The m atoms M of said isopolyanions can also be either a mixture of nickel, molybdenum and tungsten atoms or a mixture of cobalt, molybdenum and tungsten atoms.

Preferably, in the case where the element M is molybdenum (Mo), m is equal to 7. Likewise, preferably, in the case where the element M is tungsten (W), m is equal to 12.

The isopolyanons Mo₇O₂₄⁶⁻ and H₂W₁₂O₄₀⁶⁻ are advantageously used as active phase precursors in the context of the invention.

The heteropolyanions which can be used in the present invention are polyoxometallates of formula (HₕXₓMₘO_{y})^{q-} in which x=1, 2, 3 or 4, the other elements having the abovementioned meanings.

Heteropolyanions generally exhibit a structure in which the element X is the “central” atom and the element M is a metallic atom virtually systematically in octahedral coordination with X other than M.

Preferably, the m atoms M are either solely molybdenum atoms, or solely tungsten atoms, or a mixture of molybdenum and cobalt atoms, or a mixture of molybdenum and nickel atoms, or a mixture of tungsten and molybdenum atoms, or a mixture of tungsten and cobalt atoms, or a mixture of tungsten and nickel atoms. Preferably, the m atoms M are either solely molybdenum atoms, or a mixture of molybdenum and cobalt atoms, or a mixture of molybdenum and nickel atoms. Preferably, the m atoms M cannot be solely nickel atoms or solely cobalt atoms.

Preferably, the element X is at least one phosphorus atom or one Si atom.

Heteropolyanions are negatively charged polyoxometallate entities. In order to compensate for these negative charges, it is necessary to introduce counterions and more particularly cations. These cations can advantageously be protons H⁺, or any other cation of NH₄⁺ type, or metal cations and in particular metal cations of metals from group VIII.

In the case where the counterions are protons, the molecular structure comprising the heteropolyanion and at least one proton constitutes a heteropolyacid. The heteropolyacids which can be used as active phase precursors in the present invention can be, by way of example, phosphomolybdic acid (3H⁺.PMo₁₂O₄₀³⁻) or also phosphotungstic acid (3H⁺.PW₁₂O₄₀³⁻).

In the case where the counterions are not protons, reference is then made to heteropolyanion salt in order to designate this molecular structure. It is then possible to advantageously take advantage of the combination within the same molecular structure, via the use of a heteropolyanion salt, of the metal M and of its promoter, that is to say of the element cobalt and/or of the element nickel, which can either be in position X within the structure of the heteropolyanion, or in partial replacement of at least one atom M of molybdenum and/or of tungsten within the structure of the heteropolyanion, or in a counterion position.

Preferably, the polyoxometallates used according to the invention are the compounds corresponding to the formula (HₕXₓMₘO_{y})^{q-} in which H is hydrogen, X is an element chosen from phosphorus (P), silicon (Si), boron (B), nickel (Ni) and cobalt (Co), said element being taken alone, M is one or more element(s) chosen from molybdenum (Mo), tungsten (W), nickel (Ni), cobalt (Co) and iron (Fe), O being oxygen, h being an integer between 0 and 6, x being an integer which can be equal to 0, 1 or 2, m being an integer equal to 5, 6, 7, 9, 10, 11 and 12, y being an integer between 17 and 48 and q being an integer between 3 and 12.

More preferably, the polyoxometallates used according to the invention are the compounds corresponding to the formula (HₕXₓMₘO_{y})^{q-} h being an integer equal to 0, 1, 4 or 6, x being an integer equal to 0, 1 or 2, m being an integer equal to 5, 6, 10 or 12, y being an integer equal to 23, 24, 38, or 40 and q being an integer equal to 3, 4, 6 and 7, H, X, M and O having the abovementioned meanings.

The preferred polyoxometallates used according to the invention are advantageously chosen from the polyoxometallates of formula PMo₁₂O₄₀³⁻, HPCoMo₁₁O₄₀⁶⁻, HPNiMo₁₁O₄₀⁶⁻, P₂Mo₅O₂₃⁶⁻, Co₂Mo₁₀O₃₈H₄⁶⁻, CoMo₆O₂₄H₆⁴⁻, taken alone or as a mixture.

Preferred polyoxometallates which can advantageously be used in the process according to the invention are the “Anderson” heteropolyanions of general formula XM₆O₂₄^{q-} for which the m/x ratio is equal to 6 and in which the elements X and M and the charge q have the abovementioned meanings. The element X is thus an element chosen from phosphorus (P), silicon (Si), boron (B), nickel (Ni) and cobalt (Co), said element being taken alone, M is one or more element(s) chosen from molybdenum (Mo), tungsten (W), nickel (Ni) and cobalt (Co), and q is an integer between 1 and 20 and preferably between 3 and 12.

The particular structure of said “Anderson” heteropolyanions is described in the paper, Nature, 1937, 150, 850. The structure of said “Anderson” heteropolyanions comprises 7 octahedra located in one and the same plane and connected together by the edges: out of the 7 octahedra, 6 octahedra surround the central octahedron containing the element X.

The Anderson heteropolyanions containing, within their structures, cobalt and molybdenum or nickel and molybdenum are preferred. The Anderson heteropolyanions of formula CoMo₆O₂₄H₆³⁻ and NiMo₆O₂₄H₆⁴⁻ are particularly preferred. In accordance with the formula, in these Anderson heteropolyanions, the cobalt and nickel atoms are respectively the X heteroelements of the structure.

In the case where the Anderson heteropolyanion contains, within its structure, cobalt and molybdenum, a mixture of the two forms, monomeric of formula CoMo₆O₂₄H₆³⁻ and dimeric of formula Co₂Mo₁₀O₃₈H₄⁶⁻, of said heteropolyanion, the two forms being in equilibrium, can advantageously be used. In the case where the Anderson heteropolyanion contains, within its structure, cobalt and molybdenum, said Anderson heteropolyanion is preferably dimeric, of formula Co₂Mo₁₀O₃₈H₄⁶⁻.

In the case where the Anderson heteropolyanion contains, within its structure, nickel and molybdenum, a mixture of the two forms, monomeric of formula NiMo₆O₂₄H₆⁴⁻ and dimeric of formula Ni₂Mo₁₀O₃₈H₄⁸⁻, of said heteropolyanion, the two forms being in equilibrium, can advantageously be used. In the case where the Anderson heteropolyanion contains, within its structure, nickel and molybdenum, said Anderson heteropolyanion is preferably monomeric, of formula NiMo₆O₂₄H₆⁴⁻.

Anderson heteropolyanion salts can also advantageously be used as active phase precursors according to the invention. Said Anderson heteropolyanion salts are advantageously chosen from the cobalt or nickel salts of the monomeric 6-molybdocobaltate ion respectively of formula CoMo₆O₂₄H₆³⁻.3/2CO²⁺ or CoMo₆O₂₄H₆³⁻.3/2Ni²⁺ exhibiting an atomic ratio of said promoter (Co and/or Ni)/Mo of 0.41, the cobalt or nickel salts of the dimeric decamolybdocobaltate ion of formula CO₂Mo₁₀O₃₈H₄⁶⁻.3CO²⁺ or Co₂Mo₁₀O₃₈H₄⁶⁻.3Ni²⁺ exhibiting an atomic ratio of said promoter (Co and/or Ni)/Mo of 0.5, the cobalt or nickel salts of the 6-molybdonickellate ion of formula NiMo₆O₂₄H₆⁴⁻.2Co²⁺ or NiMo₆O₂₄H₆⁴⁻.2Ni²⁺ exhibiting an atomic ratio of said promoter (Co and/or Ni)/Mo of 0.5, and the cobalt or nickel salts of the dimeric decamolybdonickellate ion of formula Ni₂Mo₁₀O₃₈H₄⁸⁻.4Co²⁺ or Ni₂Mo₁₀O₃₈H₄⁸⁻.4Ni²⁺ exhibiting an atomic ratio of said promoter (Co and/or Ni)/Mo of 0.6.

The very preferred Anderson heteropolyanion salts used in the invention are chosen from the dimeric heteropolyanion salts including cobalt and molybdenum within their structure of formula CO₂Mo₁₀O₃₈H₄⁶⁻.3CO²⁺ and Co₂Mo₁₀O₃₈H₄⁶⁻.3Ni²⁺. An even more preferred Anderson heteropolyanion salt is the dimeric Anderson heteropolyanion salt of formula CO₂Mo₁₀O₃₈H₄⁶⁻.3Co²⁺.

Other preferred polyoxometallates which can advantageously be used in the process according to the invention are the “Keggin” heteropolyanions of general formula XM₁₂O₄₀^{q-} for which the m/x ratio is equal to 12 and the “lacunary Keggin” heteropolyanions of general formula XM₁₁O₃₉^{q-} for which the m/x ratio is equal to 11 and in which the elements X and M and the charge q have the abovementioned meanings. X is thus an element chosen from phosphorus (P), silicon (Si), boron (B), nickel (Ni) and cobalt (Co), said element being taken alone, M is one or more element(s) chosen from molybdenum (Mo), tungsten (W), nickel (Ni) and cobalt (Co), and q is an integer between 1 and 20 and preferably between 3 and 12.

Said Keggin entities are advantageously obtained for pH ranges which can vary according to the production routes described in the publication by A. Griboval, P. Blanchard, E. Payen, M. Fournier and J. L. Dubois, Chem. Lett., 1997, 12, 1259.

A preferred Keggin heteropolyanion, advantageously used according to the invention, is the heteropolyanion of formula PMo₁₂O₄₀³⁻ or PW₁₂O₄₀³⁻ or SiMo₁₂O₄₀⁴⁻ or SiW₁₂O₄₀⁴⁻.

The preferred Keggin heteropolyanion can also advantageously be used in the invention in its heteropolyacid form of formula PMo₁₂O₄₀³⁻.3H⁺ or PW₁₂O₄₀O³⁻.3H⁺ or SiMo₁₂O₄₀⁴⁻.4H⁺ or SiW₁₂O₄₀⁴⁻.4H⁺.

Salts of heteropolyanions of Keggin or lacunary Keggin type can also advantageously be used according to the invention. Preferred salts of heteropolyanions or of heteropolyacids of Keggin and lacunary Keggin type are advantageously chosen from the cobalt or nickel salts of phosphomolybdic, silicomolybdic, phosphotungstic or silicitungstic acids. Said salts of heteropolyanions or of heteropolyacids of Keggin or lacunary Keggin type are described in the patent U.S. Pat. No. 2,547,380. Preferably, a salt of heteropolyanion of Keggin type is nickel phosphotungstate of formula 3/2Ni²⁺.PW₁₂O₄₀³⁻ exhibiting an atomic ratio of the metal from group VIb to the metal from group VIII, that is to say Ni/W, of 0.125.

Another preferred polyoxometallate which can advantageously be used as precursor employed in the process according to the invention is the Strandberg heteropolyanion of formula HₕP₂Mo₅O₂₃^{(6-h)-}, h being equal to 0, 1 or 2 and for which the m/x ratio is equal to 5/2.

The preparation of said Strandberg heteropolyanions and in particular of said heteropolyanion of formula HₕP₂Mo₅O₂₃^{(6-h)-} is described in the paper by W-C. Cheng and N. P. Luthra, J. Catal., 1988, 109, 163.

Thus, by virtue of various preparation methods, many polyoxometallates and their associated salts are available. In general, all these polyoxometallates and their associated salts can advantageously be used during the electrolysis carried out in the process according to the invention. However, the preceding list is not exhaustive and other combinations can be envisaged.

Precursors Comprising at Least One Metal from Group VIII:

The preferred elements from group VIII are nonnoble elements: they are chosen from Ni, Co and Fe. Preferably, the elements from group VIII are Co and Ni. The metal from group VIII can be introduced in the form of salts, chelating compounds, alkoxides or glycoxides. The sources of elements from group VIII which can advantageously be used in the form of salts are well known to a person skilled in the art. They are chosen from nitrates, sulfates, hydroxides, phosphates, carbonates and halides chosen from chlorides, bromides and fluorides.

Said precursor comprising at least one metal from group VIII is partially soluble in an aqueous phase or in an organic phase. The solvents used are generally water, an alkane, an alcohol, an ether, a ketone, a chlorinated compound or an aromatic compound. Aqueous acid solution, toluene, benzene, dichloromethane, tetrahydrofuran, cyclohexane, n-hexane, ethanol, methanol and acetone are preferably used.

The metal from group VIII is preferably introduced in the acetylacetonate or acetate form when an organic solvent is used, in the nitrate form when the solvent is water and in the hydroxide or carbonate or hydroxycarbonate form when the solvent is water at acidic pH, i.e less than 7, advantageously less than 2.

Other Compounds

Moreover, any organic compound or any other doping element can be introduced at any stage mentioned above or in an additional stage. In particular, said organic compound is advantageously deposited by impregnation, before the impregnation of the metal precursors, in coimpregnation with the metal precursors or in postimpregnation after impregnation of the metal precursors.

Said organic compound can be chosen from all the organic compounds known to a person skilled in the art and is selected in particular from chelating agents, nonchelating agents, reducing agents or nonreducing agents. It can also be chosen from mono-, di- or polyalcohols which are optionally etherified, carboxylic acids, sugars, noncyclic mono-, di- or polysaccharides, such as glucose, fructose, maltose, lactose or sucrose, esters, ethers, crown ethers, cyclodextrins and compounds containing sulfur or nitrogen, such as nitriloacetic acid, ethylenediaminetetraacetic acid or diethylenetriamine, alone or as a mixture. Said doping element can be chosen from B, P or Si precursors.

Process for the Preparation of the Catalytic Material

Stage a)

The electrolysis method according to the invention consists in preparing a solution comprising at least one precursor of the catalytic material comprising at least one metal from group VIb in partially reduced form by the application of a cathodic current aimed at maximizing, in this solution, the amount of metal from group VIb reduced to a lower valency. In the electrolysis method according to the invention, a compartmentalized electrolysis system is used. It is formed of two distinct electrochemical compartments separated by a membrane or a separator. A filter press system known to a person skilled in the art can be used. For the separator, an ion exchange membrane is preferred, in order to guarantee better selectivity in the transportation of the ions and to reduce the phenomena of migration of the entities. A perfluorosulfonated membrane (such as the membranes sold under the Nafion® or Aquivion® names) is preferentially used.

It is possible to carry out the electrolysis at controlled potential or else at controlled current with potential safety devices. The principle is to maximize the amount of precursor comprising at least one reduced metal from group VIb. In the case where the reduction potential is controlled, in particular using a reference electrode, the change in the current is monitored until the latter becomes weak, a sign that most of the precursor(s) comprising at least one metal from group VIb has/have been converted. In the case where the current is controlled, the potential is limited to a certain value in order not to generate a significant side reaction, such as the degradation of the solvent. In this case, reference is made to the potential of the cathode, if a reference electrode is used, or, in the absence of a reference, to the overall electrolysis voltage value.

The reduction potential range is defined beforehand. This reduction potential is deduced from the voltammetry curves under conditions similar to those of the electrolysis, namely same electrode material, same pH and same concentration of catalyst precursor comprising at least one metal from group VIb. The cathodic potential targeted for the electrolysis is necessarily greater (in absolute value) than the potential of the first reduction wave observed in cyclic voltammetry, depending on the nature of the catalyst precursors comprising at least one metal from group VIb, on their concentration, on the solvent or on the nature of the electrode material. The potential is then chosen between the reduction potential of the catalyst precursor comprising at least one metal from group VIb and the reduction potential of the solvent, so that, when the electrolysis is carried out in potensiostatic mode, the residual current once the entities are reduced is low (<⅕ of the initial current for reduction of the catalyst precursors comprising at least one metal from group VIb, preferentially< 1/10 of this current). This makes it possible to ensure that the side reactions (electrolysis of the solvent, for example) are minimal and thus that the yield for reduction of the catalyst precursors comprising at least one metal from group VIb is high.

The concentration of metal from degree VI in the catholyte (electrolyte in the vicinity of the cathode) is between 0.1M and 8M of metal, and preferentially between 0.8M and 5M of metal. The solvent used to dissolve the catalyst precursors comprising at least one metal from group VIb is selected from water, alcohols, preferentially ethanol, polar solvents of alkyl carbonate type (such as dimethyl carbonate, diethyl carbonate, propylene carbonate), DMF or DMSO, taken alone or as mixtures. Surprisingly, the applicant company has observed that the electrochemical reduction of POMs in ethanol was preferable to an aqueous medium because it did not result in any deposition on the electrode.

It should be noted that it is not necessary to add a support salt for the electrolysis, since the polyoxometallates provide a sufficient ionic conductivity in the medium to carry out the electrolysis. It is nevertheless possible (but not obligatory) to incorporate a Ni or Co salt in the catholyte so as to incorporate in situ promoter ions for the catalysis.

The material constituting the cathode is chosen from metals (Pt, W, Ni, Au, or any other platinized metal, such as titanium or stainless steel), or certain carbons, such as glassy carbon, or certain low-porosity graphites (for example graphites coated with a deposit of pyrolytic carbon, such as the Fabmate-BG® grade from Poco-Graphite®). A platinized metal is, for example, a good cost/performance compromise.

The anodic reaction can vary, but the nature of the cationic entities which migrate through the membrane and the consequences which this migration might have on the speciation or the solubility of the catalyst precursors comprising at least one metal from group VIb or also on the final activity of the catalyst is ascertained. Typically, for polyoxometallates which are stable in an acidic medium, an anodic reaction resulting in a release of protons will be preferred, the latter migrating through the membrane and joining the catholyte to balance the electroneutrality.

An anodic reaction of use for the invention is the oxidation of water. For this, the anolyte is preferentially an aqueous sulfuric acid solution.

The range of current density of use for the invention is between 5 and 500 mA/cm² and preferably between 10 and 200 mA/cm².

The solvent used in stage a) is aqueous or organic. When the solvent is organic and the precursor comprising at least one metal from group VIb is a polyoxometallate, it generally consists of an alcohol. When the precursor of the catalytic material comprising at least one metal from group VIb is a polyoxometallate, water and ethanol are then preferably used.

Impregnation Stage b)

Stage b) is a stage of impregnation of said support with said solution obtained in stage a). Impregnations are well known to a person skilled in the art. The impregnation method according to the invention is chosen from dry impregnation or excess impregnation.

Preferably, said stage b) is carried out by dry impregnation, which consists in bringing the electroconductive support for the catalytic material into contact with a solution containing at least one precursor of the active phase comprising at least one metal from group VIb, obtained on conclusion of stage a) of the preparation process, and the volume of the solution of which is between 0.25 and 1.5 times the volume of the support to be impregnated.

Advantageously, after the impregnation stage b) (but before the drying stage c)), a maturation stage intended to allow the entities to diffuse to the heart of the support is carried out. The maturation stage is generally carried out at a temperature of between 17 and 50° C. and advantageously in the absence of molecular oxygen (02), preferably between 30 minutes and 24 h at ambient temperature. The atmosphere should preferably be devoid of 02 in order to avoid reoxidizing the preimpregnated precursors.

In a specific embodiment according to the invention, the process for the preparation of the catalytic material comprises an additional stage of introduction of at least one precursor of the active phase comprising at least one metal from group VIII. In this specific embodiment, the impregnation of said precursor comprising at least one metal from group VIII with the electroconductive support is carried out either:
i) before the stage of impregnation b) of the support with the solution obtained in stage a), in a “preimpregnation” stage b1) using a solution comprising at least one precursor of the active phase comprising at least one metal from group VIII;
ii) during the impregnation stage b), in coimpregnation with said solution comprising at least one precursor of the active phase comprising at least one partially reduced metal from group VIb obtained in stage a). In this specific embodiment, the precursor of the active phase comprising at least one metal from group VIII is introduced into the solution comprising at least one precursor of the active phase comprising at least one metal from group VIb, either before the electrolysis stage a) or after the electrolysis stage a) (but before the impregnation stage b));
iii) after the drying stage c), in a “postimpregnation” stage b2), using a solution containing at least one precursor of the active phase comprising at least one metal from group VIII. In this specific embodiment, an optional second stage of maturation and a second stage of drying c2) at a temperature of less than 250° C., preferably of less than 180° C., can be carried out under the same conditions as the conditions described during the stages of maturation of the precursor of the active phase comprising at least one metal from group VIb and in the drying stage c) described below;
iv) after the sulfurization stage d), in a “postimpregnation” stage b3) using a solution comprising at least one precursor of the active phase comprising at least one metal from group VIII. In this specific embodiment, it is optionally possible to carry out a new maturation stage, a new drying stage c3), at a temperature of less than 250° C., preferably of less than 180° C., and advantageously a new sulfurization stage d3).

All the stages explained in points i), ii), iii) and iv) are preferably carried out in an atmosphere devoid of O2.

Drying Stage c)

The drying of the precursor obtained in stage b) is intended to remove the impregnation solvent. The atmosphere is preferably devoid of 02 in order to avoid reoxidizing the preimpregnated reduced precursors. The temperature should not exceed 250° C., preferably 180° C., in order to keep intact said precursors deposited at the surface of the support. More preferentially, the temperature will not exceed 120° C. Very preferably, the drying is carried out under vacuum at a temperature not exceeding 60° C. Alternately, this stage can be carried out by passing an inert gas flow. The drying time is between 30 min and 16 h. Preferably, the drying time does not exceed 4 hours.

Stage d)

The sulfurization carried out during stage d) is intended to at least partially sulfurize the metal from group VI and optionally at least partially sulfurize the metal from group VIII. The sulfurization staged) can advantageously be carried out using a H₂S/H₂ or H₂S/N₂ gas mixture containing at least 5% by volume of H₂S in the mixture or under a flow of pure H₂S at a temperature of between 100 and 600° C., under a total pressure equal to or greater than 0.1 MPa, for at least 2 hours.

Preferably, when the precursor of the catalytic material comprises at least one metal from group VIII and at least one metal from group VIb, the sulfurization temperature is between 350° C. and 550° C.

Preferably, when the precursor of the catalytic material solely comprises only at least one metal from group VIb, the sulfurization temperature is between 100° C. and 250° C. or between 400° C. and 600° C.

Catalytic Material

The activity of the catalytic material of the electrode capable of being used for electrochemical reduction reactions, and in particular for the production of hydrogen by electrolysis of water, is ensured by an element from group VIb and by at least one element from group VIII.

Advantageously, the active function is chosen from the group formed by the combinations of the elements nickel-molybdenum or cobalt-molybdenum or nickel-cobalt-molybdenum or nickel-tungsten or nickel-molybdenum-tungsten.

The molybdenum (Mo) content is generally between 4% and 60% by weight of Mo element, with respect to the weight of the final catalytic material, and preferably between 7% and 50% by weight, with respect to the weight of the final catalytic material, obtained after the last preparation stage, i.e. after the sulfurization.

The tungsten content (W) is generally between 7% and 70% by weight of W element, with respect to the weight of the final catalytic material, and preferably between 12% and 60% by weight, with respect to the weight of the final catalytic material, obtained after the last preparation stage, i.e. the sulfurization.

The surface density, which corresponds to the amount of molybdenum Mo and tungsten W atoms deposited per unit area of support, will advantageously be between 0.5 and 20 atoms of [Mo+W] per square nanometer of support and preferably between 1 and 15 atoms of [Mo+W] per square nanometer of support.

The promoter elements from group VIII are advantageously present in the catalytic material at a content of between 0.1% and 15% by weight of element from group VIII, preferably between 0.5% and 10% by weight, with respect to the weight of the final catalytic material obtained after the last preparation stage, i.e. the sulfurization.

Support

The support for the catalytic material is a support comprising at least one electroconductive material.

In one embodiment according to the invention, the support for the catalytic material comprises at least one material chosen from carbon structures of carbon black, graphite, carbon nanotubes or graphene type.

In one embodiment according to the invention, the support for the catalytic material comprises at least one material chosen from gold, copper, silver, titanium or silicon.

A porous and nonelectroconductive material can be rendered electroconductive by depositing an electroconductive material at the surface thereof; mention may be made, for example, of a refractory oxide, such as an alumina, within which graphitic carbon is deposited.

The support for the catalytic material advantageously exhibits a BET specific surface (SS) of greater than 75 m²/g, preferably of greater than 100 m²/g, very preferably of greater than 130 m²/g.

Electrode

The catalytic material capable of being obtained by the preparation process according to the invention can be used as electrode catalytic material capable of being used for electrochemical reactions, and in particular for the electrolysis of water in a liquid electrolytic medium.

Advantageously, the electrode comprises a catalytic material obtained by the preparation process according to the invention and a binder.

The binder is preferably a polymer binder chosen for its capacities to be deposited in the form of a layer of variable thickness and for its capacities for ionic conduction in an aqueous medium and for diffusion of dissolved gases. The layer of variable thickness, advantageously of between 1 and 500 μm, in particular of the order of 10 to 100 μm, can in particular be a gel or a film.

Advantageously, the ionic conductive polymer binder is:
either conductive of anionic groups, in particular of hydroxy group, and is chosen from the group comprising in particular:
   polymers stable in an aqueous medium, which can be perfluorinated, partially fluorinated or nonfluorinated and which exhibit cationic groups making possible the conduction of hydroxide anions, said cationic groups being of quaternary ammonium, guanidinium, imidazolium, phosphonium, pyridinium or sulfide type;
   ungrafted polybenzimidazole;
   chitosan; and
   mixtures of polymers comprising at least one of the various polymers mentioned above, said mixture having anionic conductive properties;
or conductive of cationic groups making possible the conduction of protons and is chosen from the group comprising in particular:
   polymers which are stable in an aqueous medium, which can be perfluorinated, partially fluorinated or nonfluorinated and which exhibit anionic groups making possible the conduction of protons;
   grafted polybenzimidazole;
   chitosan; and
   mixtures of polymers comprising at least one of the various polymers mentioned above, said mixture having cationic conductive properties.

Mention may in particular be made, among the polymers which are stable in an aqueous medium and which exhibit cationic groups making possible the conduction of anions, of polymer chains of perfluorinated type, such as, for example, polytetrafluoroethylene (PTFE), of partially fluorinated type, such as, for example, polyvinylidene fluoride (PVDF), or of nonfluorinated type, such as polyethylene, which will be grafted with anionic conductive molecular groups.

Among the polymers which are stable in an aqueous medium and which exhibit anionic groups making possible the conduction of protons, consideration may be given to any polymer chain stable in an aqueous medium containing groups such as —SO₃⁻, —COO⁻, —PO₃²⁻, —PO₃H⁻ or —C₆H₄O⁻. Mention may in particular be made of Nafion®, sulfonated and phosphonated polybenzimidazole (PBI), sulfonated or phosphonated polyetheretherketone (PEEK).

In accordance with the present invention, any mixture comprising at least two polymers, one at least of which is chosen from the groups of polymers mentioned above, can be used, provided that the final mixture is ionic conductive in an aqueous medium. Thus, mention may be made, by way of example, of a mixture comprising a polymer stable in an alkaline medium and exhibiting cationic groups making possible the conduction of hydroxide anions with a polyethylene not grafted by anionic conductive molecular groups, provided that this final mixture is anionic conductive in an alkaline medium. Mention may also be made, by way of example, of a mixture of a polymer stable in an acidic or alkaline medium and exhibiting anionic or cationic groups making possible the conduction of protons or hydroxides and of grafted or ungrafted polybenzimidazole.

Advantageously, polybenzimidazole (PBI) is used in the present invention as binder. It is not intrinsically a good ionic conductor but, in an alkaline or acidic medium, it proves to be an excellent polyelectrolyte with respectively very good anionic or cationic conduction properties. PBI is a polymer generally used, in the grafted form, in the manufacture of proton conductive membranes for fuel cells, in membrane-electrode assemblies and in PEM-type electrolyzers, as an alternative to Nafion®. In these applications, the PBI is generally functionalized/grafted, for example by a sulfonation, in order to render it proton conductive. The role of PBI in this type of system is then different from that which it has in the manufacture of the electrodes according to the present invention, where it is used only as binder and has no direct role in the electrochemical reaction.

Even if its long-term stability in a concentrated acid medium is limited, chitosan, which can also be used as an anionic or cationic conductive polymer, is a polysaccharide exhibiting ionic conduction properties in a basic medium which are similar to those of PBI (G. Couture, A. Alaaeddine, F. Boschet and B. Ameduri, Progress in Polymer Science, 36 (2011), 1521-1557).

Advantageously, the electrode according to the invention is formulated by a process which additionally comprises a stage of removal of the solvent at the same time as or after stage 3).

Removal of the solvent can be carried out by any technique known to a person skilled in the art, in particular by evaporation or phase inversion.

In the case of evaporation, the solvent is an organic or inorganic solvent, the evaporation temperature of which is less than the decomposition temperature of the polymer binder used. Mention may be made, by way of examples, of dimethyl sulfoxide (DMSO) or acetic acid. A person skilled in the art is capable of choosing the organic or inorganic solvent suitable for the polymer or for the polymer mixture used as binder and likely to be evaporated.

According to a preferred embodiment of the invention, the electrode is capable of being used for the electrolysis of water in an alkaline liquid electrolyte medium and the polymer binder is then an anionic conductor in an alkaline liquid electrolyte medium, in particular a conductor of hydroxides.

Within the meaning of the present invention, alkaline liquid electrolyte medium is understood to mean a medium, the pH of which is greater than 7, advantageously greater than 10.

The binder is advantageously conductive of hydroxides in an alkaline medium. It is chemically stable in electrolysis baths and has the capacity to diffuse and/or transport the OH⁻ ions involved in the electrochemical reaction to the surface of the particles, which are seats of redox reactions for the production of H₂ and O₂ gases. Thus, a surface which is not in direct contact with the electrolyte is all the same involved in the electrolysis reaction, a key point in the effectiveness of the system. The binder chosen and the shaping of the electrode do not hinder the diffusion of the gases formed and limit their adsorption, thus making possible their discharge. According to another preferred embodiment of the invention, the electrode is capable of being used for the electrolysis of water in an acidic liquid electrolyte medium and the polymer binder is a cationic conductor in an acidic liquid electrolyte medium, in particular conductive of protons.

Within the meaning of the present invention, acidic medium is understood to mean a medium, the pH of which is less than 7, advantageously less than 2.

A person skilled in the art, in the light of their general knowledge, will be capable of defining the amounts of each component of the electrode. The density of the particles of catalytic material must be sufficient to reach their electrical percolation threshold.

According to a preferred embodiment of the invention, the polymer binder/catalytic material ratio by weight is between 5/95 and 95/5, preferably between 10/90 and 90/10 and more preferentially between 10/90 and 40/60.

Process for the Preparation of the Electrode

The electrode can be prepared according to techniques well known to a person skilled in the art. More particularly, the electrode is formulated by a preparation process comprising the following stages:
1) at least one ionic conductive polymer binder is dissolved in a solvent or a solvent mixture;
2) at least one catalytic material prepared according to the invention, in powder form, is added to the solution obtained in stage 1) in order to obtain a mixture; stages 1) and 2) being carried out in any order or simultaneously;
3) the mixture obtained in stage 2) is deposited on a metallic or metallic-type conductive support or collector.

Within the meaning of the invention, catalytic material powder is understood to mean a powder consisting of particles of micron, submicron or nanometer size. The powders can be prepared by techniques known to a person skilled in the art.

Within the meaning of the invention, metallic-type support or collector is understood to mean any conductive material having the same conduction properties as metals, for example graphite or certain conductive polymers, such as polyaniline and polythiophene. This support can have any shape making possible the deposition of the mixture obtained (between the binder and the catalytic material) by a method chosen from the group comprising in particular dipping, printing, induction, pressing, coating, spin coating, filtration, vacuum deposition, spray deposition, casting, extrusion or rolling. Said support or said collector can be continuous or openwork. Mention may be made, as example of support, of a grid (openwork support) or a plate or a sheet of stainless steel (304L or 316L, for example) (continuous supports).

The advantage of the mixture according to the invention is that it can be deposited on a continuous or openwork collector, by the usual easily accessible deposition techniques which make possible deposition in the forms of layers of variable thicknesses, ideally of the order of 10 at 100 μm.

In accordance with the invention, the mixture can be prepared by any technique known to a person skilled in the art, in particular by mixing the binder and the at least one catalytic material in powder form in a solvent or a mixture of solvents suitable for the achievement of a mixture with the rheological properties making possible the deposition of the electrode materials in the form of a film of controlled thickness on an electron conductive substrate. The use of the catalytic material in powder form makes possible maximization of the surface area developed by the electrodes and enhancement of the associated performance qualities. A person skilled in the art will be able to make the choices of the various formulation parameters in the light of their general knowledge and of the physicochemical characteristics of said mixtures.

### Operating Processes

Another subject matter according to the invention relates to an electrolysis device comprising an anode, a cathode and an electrolyte, in which at least one of the anode or of the cathode is an electrode according to the invention.

The electrolysis device can be used as a water electrolysis device for the production of a gaseous mixture of hydrogen and oxygen and/or the production of hydrogen alone comprising an anode, a cathode and an electrolyte, said device being characterized in that one at least of the cathode or of the anode is an electrode according to the invention, preferably the cathode.

The electrolysis device consists of two electrodes (an anode and a cathode, which are electron conductors) connected to a direct current generator and separated by an electrolyte (ionic conductive medium). The anode is the seat of the oxidation of the water. The cathode is the seat of the reduction of the protons and the formation of hydrogen.

The electrolyte can be:
either an acidic (H₂SO₄ or HCl, and the like) or basic (KOH) aqueous solution;
or a proton exchange polymer membrane which ensures the transfer of the protons from the anode to the cathode and makes possible the separation of the anode and cathode compartments, which prevents the entities reduced at the cathode from reoxidizing at the anode, and vice versa;
or a ceramic membrane conductive of O₂⁻ ions. Reference is then made to a solid oxide electrolysis (SOEC or Solid Oxide Electrolyzer Cell).

The minimum water supply of an electrolysis device is 0.8 l/Sm³ of hydrogen. In practice, the actual value is close to 1 l/Sm³. The water introduced must be as pure as possible because the impurities remain in the equipment and accumulate over the course of the electrolysis, ultimately disrupting the electrolytic reactions by:
the formation of sludges; and by
the action of chlorides on the electrodes.

An important specification with regard to the water relates to its ionic conductivity (which must be less than a few μS/cm).

There are many suppliers offering very diversified technologies, in particular in terms of the nature of the electrolyte and associated technology, ranging from a possible upstream coupling with a renewable electricity supply (photovoltaic or wind power) to the direct final provision of pressurized hydrogen.

The reaction has a standard potential of −1.23 V, which means that it ideally requires a potential difference between the anode and the cathode of 1.23 V. A standard cell usually operates under a potential difference of 1.5 V and at ambient temperature. Some systems can operate at higher temperature. This is because it has been shown that the electrolysis under high temperature (HTE) is more efficient than the electrolysis of water at ambient temperature, on the one hand because a portion of the energy required for the reaction can be contributed by the heat (cheaper than electricity) and, on the other hand, because the activation of the reaction is more efficient at high temperature. HTE systems generally operate between 100° C. and 850° C.

The electrolysis device can be used as a nitrogen electrolysis device for the production of ammonia, comprising an anode, a cathode and an electrolyte, said device being characterized in that one at least of the cathode or of the anode is an electrode according to the invention, preferably the cathode.

The electrolysis device consists of two electrodes (an anode and a cathode, which are electron conductors) connected to a direct current generator and separated by an electrolyte (ionic conductive medium). The anode is the seat of the oxidation of the water. The cathode is the seat of the nitrogen reduction and the ammonia formation. Nitrogen is continuously injected into the cathode compartment.

The nitrogen reduction reaction is:

N₂+6H⁺+6e⁻→2NH₂

The electrolyte can be:
either an aqueous solution (Na₂SO₄ or HCl), preferably saturated with nitrogen;
or a proton exchange polymer membrane which ensures the transfer of the protons from the anode to the cathode and makes possible the separation of the anode and cathode compartments, which prevents the entities reduced at the cathode from reoxidizing at the anode, and vice versa.

The electrolysis device can be used as a carbon dioxide electrolysis device for the production of formic acid, comprising an anode, a cathode and an electrolyte, said device being characterized in that one at least of the cathode or of the anode is an electrode according to the invention. An example of anode and of electrolyte which can be used in such a device is described in detail in the document FR 3 007 427.

The electrolysis device can be used as a fuel cell device for the production of electricity from hydrogen and oxygen comprising an anode, a cathode and an electrolyte (liquid or solid), said device being characterized in that one at least of the cathode or of the anode is an electrode according to the invention.

The fuel cell device consists of two electrodes (an anode and a cathode, which are electron conductors) which are connected to a charge C for delivering the electric current produced and which are separated by an electrolyte (ionic conductive medium). The anode is the seat of the oxidation of the hydrogen. The cathode is the seat of the reduction of the oxygen.

The electrolyte can be:
either an acidic (H₂SO₄ or HCl, and the like) or basic (KOH) aqueous solution;
or a proton exchange polymer membrane which ensures the transfer of the protons from the anode to the cathode and makes possible the separation of the anode and cathode compartments, which prevents the entities reduced at the cathode from reoxidizing at the anode, and vice versa;
or a ceramic membrane conductive of O₂⁻ ions. Reference is then made to a solid oxide fuel cell (SOFC).

The following examples illustrate the present invention without, however, limiting the scope thereof. The examples below relate to the electrolysis of water in a liquid electrolytic medium for the production of hydrogen.

### EXAMPLES

### Example 1: Preparation of an Electroreduced Solution Based on 3M H₃PMo₁₂O₄₀ in Aqueous Solution+Ni₅(OH)₆(CO₃)₂ in a Proportion of [Ni]=0.6 mol/l

30 ml of solution of H₃PMo₁₂O₄₀ in water with [Mo]=3 mol/l, i.e. 17.7 g of HPA, which are additivated with Ni₅(OH)₆(CO₃)₂ in a proportion of [Ni]=0.6 mol/l, are prepared and placed in a flask acting as cathode reservoir, which are rendered inert with nitrogen. A solution of 50 ml of 0.5M sulfuric acid is prepared and rendered inert with nitrogen in the anode reservoir. The membrane separating the two compartments of the electrolyzer is a reinforced Nafion® N324 membrane.

The working electrode is a titanium plate coated with platinum. The counterelectrode is a metal alloy based on iron-chromium-nickel. The reference electrode of Ag/AgCl type is placed in a salt bridge filled with KCl (3M) and agar, itself placed in a glass part located between the pump and the inlet of the electrolyzer, cathode side. The pumps provide a flow rate of between 10 and 20 ml/min.

The potential applied on the working electrode is then fixed so as to carry out the three successive reductions of the HPA, i.e. E=400 mV vs Ag/AgCl at first, then gradually down to 330 mV vs Ag/AgCl, to accelerate the reduction rate, the aim being to selectively reduce the molybdenum precursor and to limit the reduction of the solvent. The blue coloration of the electroreduced solution appears very quickly.

The rate of reduction of the HPA solution decreases over time, the current density gradually decreases from −30 mA/cm² to −2.4 mA/cm² in 1 hour of electrolysis, the applied potential being regularly varied from 400 mV to 300 mV vs Ag/AgCl. The amount of final charge then amounts to 1500 C after only 1 hour of electrolysis.

### Example 2: Preparation of a Catalytic Material C1 from the Electroreduced Solution of Example 1 (Based on 3M H₃PMo₁₂O₄₀ in Aqueous Solution+Ni₅(OH)₆(CO₃)₂ in a Proportion of [Ni]=0.6 mol/l)

The catalytic material C1 (in accordance) is prepared by dry impregnation of 10 g of commercial carbon-type support (Ketjenblack) with 10 ml of electroreduced solution obtained in example 1. The preparation of the catalyst is continued by a maturation stage where the impregnated solid is kept under argon for 18 hours before undergoing a final drying stage at 60° C. (oil bath) under an inert atmosphere and at reduced pressure (while pulling under vacuum). The precatalyst is sulfurized under pure H₂S at a temperature of 400° C. for 2 hours under 0.1 MPa of pressure.

On the final catalyst, the amount of Mo corresponds to 30% by weight of Mo element with respect to the weight of the final catalytic material, and the Ni and P ratios are respectively: Ni/Mo=0.2 and P/Mo=0.08.

### Example 3: Description of the Commercial Pt Catalyst (Catalyst C2)

The material C2 originates from Alfa Aesar®: it comprises platinum particles with an SBET=27 m²/g.

### Example 4: Catalytic Test

The characterization of the catalytic activity of the catalytic materials is carried out in a 3-electrode cell. This cell is composed of a working electrode, of a platinum counterelectrode and of an Ag/AgCl reference electrode. The electrolyte is a 0.5 mol/1 aqueous sulfuric acid (H₂SO₄) solution. This medium is deoxygenated by sparging with nitrogen and the measurements are made under an inert atmosphere (deaeration with nitrogen).

The working electrode consists of a disk of glassy carbon with a diameter of 5 mm set in a Teflon tip (rotating disk electrode). Glassy carbon has the advantage of having no catalytic activity and of being a very good electrical conductor. In order to deposit the catalytic materials (C1, C2) on the electrode, a catalytic ink is formulated. This ink consists of a binder in the form of a solution of 10 μl of 15% by weight Nafion®, of a solvent (1 ml of 2-propanol) and of 5 mg of catalyst (C1, C2). The role of the binder is to ensure the cohesion of the particles of the supported catalyst and the adhesion to the glassy carbon. This ink is subsequently placed in an ultrasonic bath for 30 to 60 minutes in order to homogenize the mixture. 12 μL of the prepared ink are deposited on the working electrode (described above). The ink is subsequently deposited on the working electrode and then dried in order to evaporate the solvent.

Different electrochemical methods are used to determine the performance qualities of the catalysts:
linear voltammetry: it consists in applying, to the working electrode, a potential signal which varies with time, i.e. from 0 to −0.5 V vs RHE at a rate of 2 mV/s, and in measuring the faradaic response current, that is to say the current due to the oxidation-reduction reaction taking place at the working electrode. This method is ideal for determining the catalytic power of a material for a given reaction. It makes it possible, inter alia, to determine the overvoltage necessary for the reduction of the protons to give H₂.
chronopotentiometry: it consists, for its part, in applying a current or a current density for a predetermined time and in measuring the resulting potential. This study makes it possible to determine the catalytic activity at constant current but also the stability of the system over time. It is carried out with a current density of −10 mA/cm² and for a given time.

The catalytic performance qualities are collated in table 1 below. They are expressed as overvoltage at a current density of −10 mA/cm².

TABLE 1

| | Overvoltage at −10 mA/cm² |
|---|---|
| Catalytic materials | [(mV) vs RHE] |
| C1 | −190 |
| C2 (Platinum) | −90 |

With an overvoltage of only −190 mV vs RHE, the catalytic material C1 exhibits performance qualities relatively close to those of platinum with regard to the prior art. This result demonstrates the indisputable advantage of this material for the development of the water electrolysis hydrogen sector.

1. A process for the preparation of a catalytic material of an electrode for electrochemical reduction reactions, said material comprising at least one active phase based on a metal from group VIb and an electroconductive support, which process comprises at least the following stages:
a) a stage of electrolysis of at least one aqueous and/or organic solution comprising at least one precursor of the active phase comprising at least one metal from group VIb, in order to obtain a solution comprising at least one precursor comprising at least one partially reduced metal from group VIb;
b) a stage of impregnation of said support with said solution obtained in stage a), in order to obtain a catalytic material precursor;
c) a stage of drying said precursor obtained in stage b) at a temperature of less than 250° C., without subsequent calcination;
d) a stage of sulfurization of the catalytic material precursor obtained in stage c) at a temperature of between 100° C. and 600° C.

2. The process as claimed in claim 1, in which stage a) is carried out in an electrolyzer comprising at least two electrochemical compartments separated by a membrane or a porous separator and respectively including one the anode and the other the cathode.

3. The process as claimed in claim 1, in which the current density applied in stage a) is between 5 and 500 mA/cm².

4. The process as claimed in claim 1, in which said precursor comprising at least one metal from group VI is chosen from polyoxometallates corresponding to the formula (HₕXₓMₘO_{y})^{q-} in which X is an element chosen from phosphorus (P), silicon (Si), boron (B), nickel (Ni) or cobalt (Co), M is one or more metal(s) chosen from molybdenum (Mo), tungsten (W), nickel (Ni), cobalt (Co) and iron (Fe), 0 being oxygen, h being an integer between 0 and 12, x being an integer between 0 and 4, m being an integer equal to 5, 6, 7, 8, 9, 10, 11, 12 and 18, y being an integer between 17 and 72 and q being an integer between 1 and 20, it being understood that M is not a nickel atom or a cobalt atom alone.

5. The process as claimed in claim 4, in which the m atoms M are either only molybdenum (Mo) atoms, or only tungsten (W) atoms, or a mixture of molybdenum (Mo) and tungsten (W) atoms, or a mixture of molybdenum (Mo) and cobalt (Co) atoms, or a mixture of molybdenum (Mo) and nickel (Ni) atoms, or a mixture of tungsten (W) and nickel (Ni) atoms.

6. The process as claimed in claim 4, in which the m atoms M are either a mixture of nickel (Ni), molybdenum (Mo) and tungsten (W) atoms or a mixture of cobalt (Co), molybdenum (Mo) and tungsten (W) atoms.

7. The process as claimed in claim 1, in which at least one precursor of the active phase comprising at least one metal from group VIII is introduced, said precursor being brought into contact with the electroconductive support by impregnation, either:
i) before stage b) of impregnation of said support with the solution obtained in stage a), in a “preimpregnation” stage b1) using a solution comprising at least one precursor of the active phase comprising at least one metal from group VIII;
ii) during the impregnation stage b), in coimpregnation with said solution comprising at least one precursor of the active phase comprising at least one partially reduced metal from group VIb obtained in stage a);
iii) after the drying stage c), in a “postimpregnation” stage b2), using a solution containing at least one precursor of the active phase comprising at least one metal from group VIII;
iv) after the sulfurization stage c), in a “postimpregnation” stage b3) using a solution comprising at least one precursor of the active phase comprising at least one metal from group VIII.

8. The process as claimed in claim 7, in which said metal from group VIII is chosen from nickel, cobalt and iron.

9. The process as claimed in claim 1, in which, when said precursor of the catalytic material comprises at least one metal from group VIb and at least one metal from group VIII, the sulfurization temperature is between 350° C. and 550° C.

10. The process as claimed in claim 1, in which, when said precursor of the catalytic material solely comprises only at least one metal from group VIb, the sulfurization temperature is between 100° C. and 250° C. or between 400° C. and 600° C.

11. The process as claimed in claim 1, in which said electroconductive support comprises at least one material chosen from carbon structures of carbon black, graphite, carbon nanotubes or graphene type.

12. The process as claimed in claim 1, in which said electroconductive support comprises at least one material chosen from gold, copper, silver, titanium or silicon.

13. An electrode, characterized in that it is formulated by a preparation process comprising the following stages:
1) at least one ionic conductive polymer binder is dissolved in a solvent or a solvent mixture;
2) at least one catalytic material prepared according to claim 1, in powder form, is added to the solution obtained in stage 1) in order to obtain a mixture;
stages 1) and 2) being carried out in any order or simultaneously;
3) the mixture obtained in stage 2) is deposited on a metallic or metallic-type conductive support or collector.

14. An electrolysis device comprising an anode, a cathode and an electrolyte, said device being characterized in that one at least of the anode or of the cathode is an electrode as claimed in claim 13.

15. A method comprising performing an electrochemical reaction with the electrolysis device as claimed in claim 14.

16. A method as in claim 15, wherein said electrolysis device is used as:
a water electrolysis device for the production of a gaseous mixture of hydrogen and oxygen and/or the production of hydrogen alone;
a carbon dioxide electrolysis device for the production of formic acid;
a nitrogen electrolysis device for the production of ammonia;
a fuel cell device for the production of electricity from hydrogen and oxygen.
